(19) United States
(12) Patent Application Publication
(10) Pub. No.: US 2026/0122751 A1
(43) Pub. Date: Apr. 30, 2026

(54) Efficient Plasma Driving

(71) Applicant: EHT Ventures LLC, Seattle, WA (US)

(72) Inventors: Alex Henson, Seattle, WA (US); Kenneth Miller, Seattle, WA (US); Alexander Vellozzi, Seattle, WA (US)

(73) Assignee: EHT Ventures LLC, Seattle, WA (US)

(21) Appl. No.: 19/375,192

(22) Filed: Oct. 30, 2025

Related U.S. Application Data
(60) Provisional application No. 63/714,847, filed on Oct. 31, 2024.

(51) Int. Cl. H05H 1/36

(52) U.S. Cl. CPC H05H 1/36

(57) ABSTRACT

A plasma driver for efficiently delivering energy to a plasma when driving arcs or arc-like plasmas through a spark gap is disclosed. A plasma driver may include an energy storage capacitor, a nanosecond pulser stage electrically coupled with the energy storage capacitor, an IPM stage electrically coupled with the nanosecond pulser stage and the energy storage capacitor, a transformer electrically having a primary side and a secondary side, the primary side electrically coupled with the nanosecond pulser stage and the IPM stage, and a device may include an output cable electrically coupled with a secondary side of the transformer.

### BACKGROUND

Plasma driver architectures have traditionally relied on pulse-forming networks, Blumlein transmission lines or commercial pulse generators drive semiconductor switches or gas-filled tubes to produce voltage impulses exceeding about 1 kV. The long interconnects and inherent parasitic inductances of these configurations often lead to degraded pulse rise times, amplitude jitter, and limited repetition rates. These solutions also have difficulty adapting to changes in the plasma characterizes between plasma ignition and plasma maintenance.

### SUMMARY

A plasma driver is disclosed to drive various industrial plasma systems. In some examples, a plasma driver including: an energy storage capacitor; a nanosecond pulser stage electrically coupled with the energy storage capacitor, wherein the nanosecond pulser stage produces high voltage pulses greater than about 1 kV; an IPM stage electrically coupled with the nanosecond pulser stage and the energy storage capacitor, wherein the IPM stage produces high voltage pulses of about 1 V-10 kV; a transformer electrically having a primary side and a secondary side, the primary side electrically coupled with the nanosecond pulser stage and the IPM stage; and an output cable electrically coupled with a secondary side of the transformer.

In some examples, a plasma driver, wherein energy is transferred and stored in the stray capacitance of the output cable.

In some examples, a plasma driver, wherein energy stored in stray capacitance of the output cable flows into a plasma coupled with the output cable.

In some examples, a plasma driver, wherein the output cable includes a capacitor and the energy stored in the capacitor flows into a plasma coupled with the plasma driver.

In some examples, a plasma driver, wherein the output cable includes a stripline and the energy stored in the stripline flows into a plasma coupled with the plasma driver.

In some examples, the plasma driver according to any of the proceeding claims, wherein the output cable is coupled with a spark gap.

In some examples, the plasma driver according to any of the proceeding claims, wherein the output cable is coupled with a dielectric barrier discharge.

In some examples, the plasma driver according to any of the proceeding claims, wherein the output cable is coupled with a plasma load.

In some examples, the plasma driver according to any of the proceeding claims, wherein the output cable includes a cable having a stray inductance less than about 100 μH and a stray capacitance less than about 1 nH.

In some examples, the plasma driver according to any of the proceeding claims, wherein the output cable capacitance includes a cable having a capacitance of about 10 pF-100 nF.

In some examples, the plasma driver according to any of the proceeding claims, wherein the output cable capacitance includes a cable having a capacitance of about 50 pF-1 nF.

In some examples, the plasma driver according to any of the proceeding claims, further including a power supply coupled with the IPM stage.

In some examples, the plasma driver according to any of the proceeding claims, wherein the nanosecond pulser stage includes a plurality of solid-state switches arranged in parallel.

In some examples, the plasma driver according to any of the proceeding claims, wherein the nanosecond pulser stage produces high voltage pulses of about 1 kV-100 kV.

In some examples, the plasma driver according to any of the proceeding claims, wherein the nanosecond pulser stage produces high voltage pulses of about 5 kV-30 kV.

In some examples, the plasma driver according to any of the proceeding claims, wherein the nanosecond pulser stage produces high voltage pulses with a pulse repetition frequency greater than about 100 Hz.

In some examples, the plasma driver according to any of the proceeding claims, wherein the nanosecond pulser stage produces high voltage pulses with a pulse repetition frequency between 1 kHz and 50 KHz.

In some examples, the plasma driver according to any of the proceeding claims, wherein the nanosecond pulser stage produces high voltage pulses with a pulse repetition frequency between 100 Hz and 1 MHz.

In some examples, the plasma driver according to any of the proceeding claims, wherein the IPM stage includes plurality of solid-state switches arranged in parallel.

In some examples, the plasma driver according to any of the proceeding claims, wherein the IPM stage produces high voltage pulses of about 1 V-1 kV

In some examples, the plasma driver according to any of the proceeding claims, wherein the IPM stage produces high voltage pulses of about 10 V-700 V.

In some examples, the plasma driver according to any of the proceeding claims, wherein the pulse repetition frequency of the IPM stage and the pulse repetition frequency of the nanosecond pulser stage are about the same.

In some examples, the plasma driver according to any of the proceeding claims, further including a second energy storage capacitor disposed between the nanosecond pulser stage and the IPM stage.

In some examples, a plasma driver, wherein the second energy storage capacitor, once charged, becomes isolated from a power supply.

In some examples, a plasma driver, wherein the second energy storage capacitor is charged when the nanosecond pulser is closed.

In some examples, a plasma driver, wherein the second energy storage capacitor has a capacitance of about 1 nF-100 μF.

In some examples, a plasma driver, wherein the second energy storage capacitor has a capacitance of about 100 nF-1 μF.

In some examples, the plasma driver according to any of the proceeding claims, wherein the stray capacitance of the output cable is less than the capacitance of the second energy storage capacitor.

In some examples, the plasma driver according to any of the proceeding claims, further including a current-limiting inductor disposed between the nanosecond pulser stage and the transformer.

In some examples, a plasma driver, wherein the current-limiting inductor has an inductance of about 1 nF-1,000 nF.

In some examples, the plasma driver according to any of the proceeding claims, further including a bleed resistor disposed across a secondary side of the transformer.

In some examples, the plasma driver according to any of the proceeding claims, further including a blocking diode disposed between the transformer and the output cable.

In some examples, the plasma driver according to any of the proceeding claims, wherein the transformer includes one or more transformers.

In some examples, the plasma driver according to any of the proceeding claims, wherein the stray capacitance of the transformer is less than about 500 pF.

In some examples, the plasma driver according to any of the proceeding claims, wherein the output voltage is positive, negative, and/or floating.

In some examples, a plasma driver including: a first energy storage capacitor; a nanosecond pulser electrically coupled with the energy storage capacitor, the nanosecond pulser including a plurality of solid state switches, wherein the nanosecond pulser stage produces high voltage pulses greater than about 1 kV, wherein the nanosecond pulser stage produces high voltage pulses with a pulse repetition frequency greater than about 100 Hz; a second energy storage capacitor; an integrated power module including a plurality of solid state switches, wherein the integrated power module is electrically coupled with the first energy storage capacitor and the nanosecond pulser via the second energy storage capacitor, wherein the integrated power module stage produces high voltage pulses of about 1 V-10 kV; a transformer having a primary side and a secondary side, the primary side having a first lead electrically coupled with the nanosecond pulser and a second lead electrically coupled with the integrated power module; and an output electrically coupled with the secondary side of the transformer.

In some examples, a plasma driver, further including an output cable electrically coupled with an output.

In some examples, a plasma driver 35 or claim 36, wherein the nanosecond pulser stage includes a plurality of solid-state switches arranged in parallel.

In some examples, a plasma driver 35-37, wherein the second energy storage capacitor, once charged, becomes isolated from a power supply.

In some examples, the plasma driver according to any of the proceeding claims, wherein the second energy storage capacitor is charged when the nanosecond pulser is closed.

In some examples, a plasma driver 35-39, wherein the second energy storage capacitor has a capacitance of about 1 nF-100 μF.

In some examples, a plasma driver 35-40, wherein the second energy storage capacitor has a capacitance of about 100 nF-1 μF.

In some examples, a plasma driver 35-41, further including a current-limiting inductor disposed between the nanosecond pulser stage and the transformer.

In some examples, a plasma driver, wherein the current-limiting inductor has an inductance of about 1 nF-1,000 nF.

In some examples, a plasma driver 35-43, further including a bleed resistor disposed across a secondary side of the transformer.

In some examples, a plasma driver 35-44, further including a blocking diode disposed between the transformer and the output cable.

In some examples, a plasma driver 35-45, wherein the transformer includes one or more transformers.

In some examples, a plasma driver 35-46, wherein the stray capacitance of the transformer is less than about 500 pF.

In some examples, a plasma driver 35-47, wherein the plurality of switches of the integrated power module are open when the plurality of switches of the nanosecond pulser are closed, and wherein the plurality of switches of the integrated power module are closed when the plurality of switches of the nanosecond pulser are open.

### BRIEF DESCRIPTION OF THE FIGURES

FIG. 1 is an illustration of a driver and load system.

FIG. 2 is an illustration of a driver and load system.

FIG. 3A is an idealized representation of a sinusoidal waveform.

FIG. 3B is an idealized representation of a pulsed waveform.

FIG. 4 shows input and output waveforms.

### DETAILED DESCRIPTION

A driver for efficiently delivering energy to a plasma when driving arcs or arc-like plasmas through a spark gap or anything similar is disclosed.

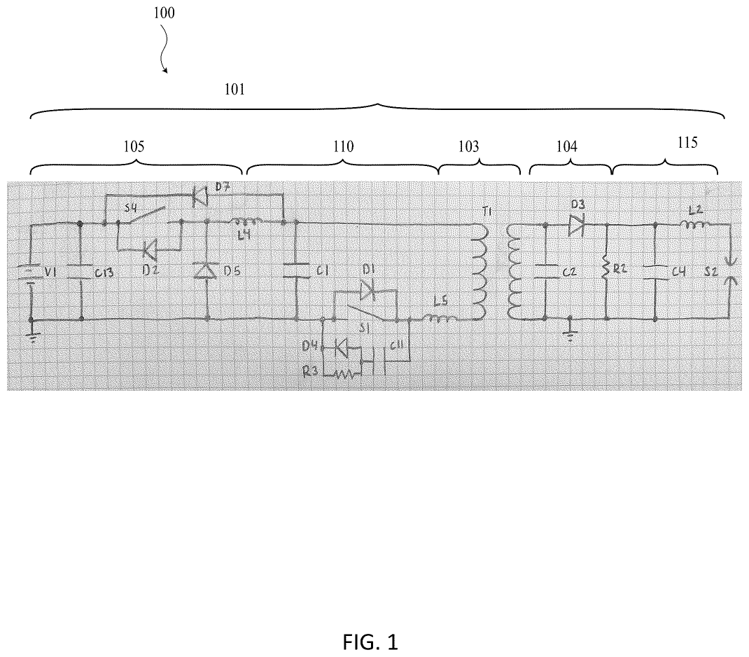

FIG. 1 is an illustration of a driver and load system 100. The driver and load system 100 includes a plasma driver 101. A plasma driver 101 may include a nanosecond pulser stage 110, an integrated power module (IPM) stage 105, one or more transformers 103, and/or an output stage 104. At the output, the plasma driver 101, may drive a spark gap S2 coupled with an output cable 115. The spark gap S2 may be part of any industrial type of process using plasma arcs or arc-like processes such as, for example, hydrogen production from methane or ammonia formation.

Various industrial processes, for example, may use electrical energy to drive arcs for a specific chemistry. Efficiency can be an important factor. The spark gap S2, for example, may include any device that is meant to drive arcs or arc-like plasmas.

The IPM stage 105, for example, includes a switch S4 (or plurality of switches) electrically coupled with a second energy storage capacitor C13 (e.g., a plurality of energy storage capacitors) and one lead of the primary side of the transformer T1. Whereas the nanosecond pulser stage 110, for example, includes a switch S1 (or plurality of switches) electrically coupled between a first energy storage capacitor C1 (e.g., a plurality of energy storage capacitors) and a second lead of the transformer T1.

The nanosecond pulser stage 110 may operate to provide an initial high voltage to the spark gap S2 through the transformer T1 to form a plasma arc. This initial high voltage, for example, may be about 1 kV-100 kV or any voltage therebetween. As another example, this initial high voltage may be about 5 kV-30 kV or any voltage therebetween. The nanosecond pulser stage 110 can drive initial high voltage pulses at a pulse repetition frequency of about 1 kHz to 50 kHz, or about 100 Hz to about 1 MHz. These pulses are not sinusoidal.

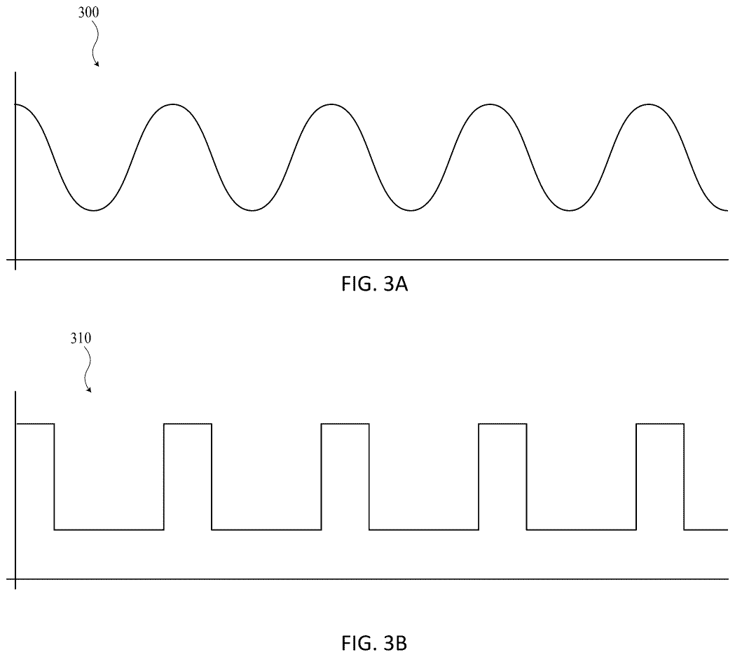

FIG. 3A is an example waveform showing a plurality of pulses. FIG. 3B is an example sinusoidal waveform.

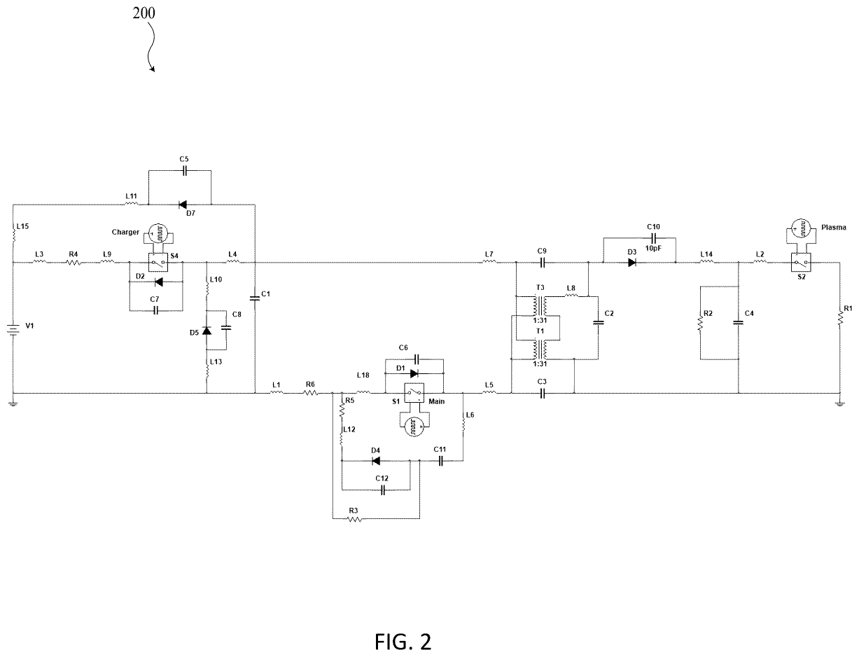

The plasma driver 101 may output positive or negative voltages. FIG. 1 and FIG. 2 illustrate a positive-output driver. Reversing the direction of the diode D3 would illustrate a negative-output driver. When voltages are mentioned in this document, such voltages may be considered absolute values and could be positive or negative voltages.

The output of the plasma driver 101, for example, may float relative to ground.

The IPM stage 105 initially charges the first energy storage capacitor C1 and then may recharge the first energy storage capacitor C1 after each pulse from the nanosecond pulser stage 110. The pulses produced by the IPM stage 105 and the nanosecond pulser stage 110, for example, may have the same pulse repetition frequency.

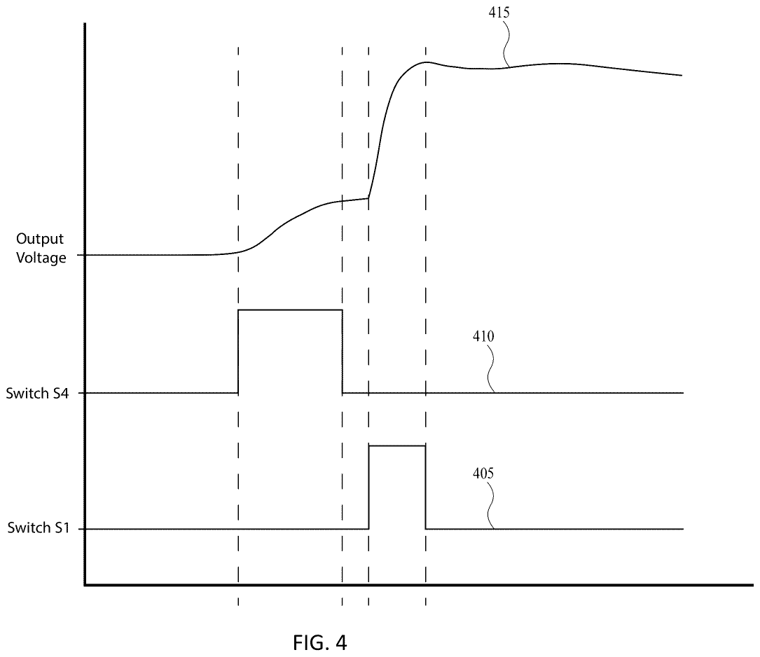

FIG. 4 shows input waveform 405 for switch S1, input waveform 410 for switch S4, and an output waveform 415. For example, switch S1 may be closed when waveform 405 is positive and switch S4 may be closed when waveform 410 is positive. Switch S4 may be closed for about 5 μs to 15 μs or about 100 ns to 100 ms. After switch S4 is opened, the switch S1 may be closed. The time between opening the switch S4 and closing the switch S1 may be about 0 ns-100 ms, or about 500 ns-2 μs. Switch S1, for example, may be closed for about 500 ns-2 μs, or about 10 ns to 10 μs. The output voltage may increase less when the switch S4 is closed than when the switch S1 is closed.

Each of the switch S4 and/or the switch S1, for example, may include one or more solid-state devices. For example, the switch S4 and/or the switch S1 may include a plurality of solid-state devices arranged in series and/or parallel. In some examples, the switch S1 and/or the switch S4 may comprise a plurality of switches were each of these switches include an IGBT, a MOSFET, a SiC MOSFET, a SiC junction transistor, a FET, a SiC switch, a GaN switch, and/or a photoconductive switch.

The nanosecond pulser stage 110 may be coupled with either lead of the transformer T1 such as, for example, on the low side of the transformer T1 (as depicted in FIG. 1 and FIG. 2) or on the high side of the transformer T1. FIG. 2 shows two transformers T1 and T3. Having the nanosecond pulser stage 110 on the low side may allow the gate drive to the switch S1 to be ground referenced. Having the nanosecond pulser stage 110 on the high side may require the gate drive to the switch S1 to be isolated from ground.

The IPM stage 105, for example, may include a second energy storage capacitor C13 coupled with an external or internal power supply VI that charges the second energy storage capacitor C13. The voltage supplied by the power supply VI may be about 1 V-10 kV, 1 V-1 kV or any voltage therebetween.

The pulsing parameters of the switch S4 and the switch S1, for example, may be controlled using drive signals, which may, for example, be set using external or internal control equipment, controllers, etc. Alternatively, the drive signals may be hardwired with the switches.

When the switch S4 is closed, the first energy storage capacitor C1 may be charged from the second energy storage capacitor C13. The impedance of the charging inductor L4 can be a tradeoff between the charge time and the current through the switch S4. For example, the charging inductor L4 can be small enough to allow for a fast pulse repetition frequency (PRF), but not so small that the current through the switch S4 is so high, that to handle the current, the switch S4 needs to be composed on many more solid-state devices.

As another example, the charging inductor L4 may not be used. In such a circuit, the switch S4 may include many more parallel solid-state devices than with the charging inductor L4. Eliminating the charging inductor L4, for example, may decrease the charging time of the first energy storage capacitor C1 and allow the plasma driver 101 to operate at higher frequencies.

The first energy storage capacitor C1, for example, may have a capacitance of about 1 nF-100 μF or about 100 nF to 1 μF such as, for example, 550 nF. The rate of charging may be limited by the charging inductor L4. The charging inductor L4, for example, may have an inductance of about 10 nH-1,000 μH or 10 μH-100 μH such as, for example, about 30 pH. Various other values may be used.

The switch S4, for example, may be closed long enough that the first energy storage capacitor C1 becomes fully charged prior to discharge. The freewheeling diode D7 may prevent the first energy storage capacitor C1 from being overcharged by redepositing the energy onto the second energy storage capacitor C13. The crowbar diode D5, for example, may allow a path for extra energy stored in the charging inductor L4 to discharge and get re-deposited onto the second energy storage capacitor C13. This may improve the input energy efficiency of the plasma driver 101. The crowbar diode D5, for example, may act like a snubber for the switch S4.

The freewheeling diode D7 and/or the crowbar diode D5 may or may not be included in the circuit.

The first energy storage capacitor C1 is separated from the snubber capacitance C11 by the inductance of the transformer T1, and the current-limiting inductor L5. This may allow for the second energy storage capacitor C13 and/or the first energy storage capacitor C1 to charge up the snubber capacitor C11. For example, current flowing on the primary side of the transformer T1 can create a flux in the transformer T1, which may result in a rise in the output voltage. The output voltage during charging is much less than the peak output voltage during the pulsing of the nanosecond pulser stage 110.

A snubber circuit may or may not be included. An example snubber circuit is shown. Various other snubber circuits may be used. The example snubber circuit includes the snubber capacitor C11, snubber R3, and snubber D4 may protect the switch S1 by reducing the amplitude of inductive voltage spikes that occur across the switch S1 devices when they open against high currents. High currents may be flowing through the switch S1 devices when few devices are used in parallel, when the transformer T1 saturate, and/or when the user's arc forms unexpectedly early.

The snubber capacitor C11, for example, may have a capacitance of about 10 nF-10 μF or about 500 nF-1,000 nF such as, for example, about 752 nF. Various other values may be used.

The snubber resistor R3, for example, may have a resistance of about 1Ω-100 kΩ or about 100Ω to 1 kΩ such as, for example, 400Ω. Various other values may be used. Alternatively or additionally, the snubber resistor may not be included.

As another example, the snubber circuit may not be used. In such a circuit, snubber capacitor C11, snubber resistor R3, and snubber diode D4 may not be included.

Not using a snubber circuit would require increasing the number of parallel solid-state devices, which compose the switch S4 and/or adding a crowbar diode. Either option may reduce the current flowing through each solid-state device and thus reduce the amplitude of voltage spikes.

The sizing of the current-limiting inductor L5 can be a tradeoff between the charge time and the current through the switch S1. For example, the current-limiting inductor L5 can be small enough to allow for a fast output rise time, but not so small that the switch S1 needs to be composed on many more solid-state devices to handle the current.

The current-limiting inductor L5, for example, may have an inductance of 1 nF-1,000 nF or about 50 nF-300 nF, such as, for example, about 165 nF.

As another example, a current-limiting inductor may not be used. In such a circuit, the switch S4 may be composed of many more parallel solid-state devices, and/or the stray inductance of transformer T1 is increased. Increasing the stray inductance of transformer T1 may be done by increasing the number of windings on the primary side of the transformer.

When the switch S4 is opened, the first energy storage capacitor C1 can become isolated from the external DC supply VI and/or the second energy storage capacitor C13, which may ensure that the only energy available during pulsing of the switch S1 is contained on the first energy storage capacitor C1. The energy on the first energy storage capacitor C1 is the maximum energy-per-pulse that can be delivered to the plasma and can be calculated using the follow equation:

$$E = \frac{1}{2} C 1 \cdot {V}_{charge}^{2}$$

Where E is the controlled energy (or maximum energy-per-pulse) stored on C1 and V is the charge voltage. From this equation, you can see that the energy-per-pulse can be controlled directly by varying the charge voltage. The energy can be driven through the transformer T1 to create a plasma at the spark gap S2.

The switch S1 may be closed when the first energy storage capacitor C1 is done charging. The closing of the switch S1, for example, may start the high voltage pulsing and the transfer of energy to any output capacitance such as, for example, the output cable 115 and/or the spark gap S2.

During pulsing, the first energy storage capacitor C1 can drain and charge the stray capacitances of the transformer C2 and/or the output cable stray capacitance C4. The output voltage can be calculated using the conservation of energy between the primary and secondary:

$$\frac{1}{2} C 1 \cdot {V}_{charge}^{2} = \frac{1}{2} ( C 2 + C 4 ) \cdot {V}_{out}^{2}$$

If the spark gap S2 contains a significant stray capacitance, that may also be included in the total output capacitance (C2+C4).

Because stray capacitance of the transformer C2 and the output cable stray capacitance C4 are so much smaller than the first energy storage capacitor first energy storage capacitor C1 to conserve energy, the output voltage Vout must be much larger than the charge voltage V_{charge}. This equation will determine the output voltage so long as the turns ratio transformer T1 is large enough. As you decrease the number of turns in transformer T1, the step-up ratio will begin to limit the output voltage and the first energy storage capacitor C1 will not fully discharge.

The transformer T1 may have a turn ration of 1:31 turns of primary windings to secondary windings. The transformer T1 may have a turn ratio of 1:50 turns of primary windings to secondary windings. The transformer T1 may have a turn ration of 1:10 or 1:100 or 1:1000 turns of primary windings to secondary windings.

The stray capacitor C2 represents the capacitance of the transformer, and can be less than about 500 pF. The capacitor C2 can be less than about 100 pF. The capacitor C2 2 can be less than about 54 pF. Reducing the capacitor C2, for example, may be important for maximizing the amount of energy transferred to the plasma formed across the spark gap S2.

When the output reaches the maximum voltage, the first energy storage capacitor C1, for example, can be fully discharged. Larger values for the output cable stray capacitance C4 can possibly take longer to charge (e.g., a longer rise time). Therefore, the pulse width of the switch S1 is such that it can charge the largest of the output cable stray capacitance C4 value.

The output cable stray capacitance C4 can be altered by using output cables of different lengths. From the above equation, you can see that the value of the output cable stray capacitance C4 influences the output voltage. As the charge voltage decreases, smaller output cable stray capacitance C4 values may be required to maintain the same output voltage. This relationship can be utilized to maintain a constant output voltage while adjusting the energy-per-pulse. Alternately, by holding the charge voltage constant and varying the value of the output cable stray capacitance C4, the same energy-per-pulse is delivered at different output voltages.

The output cable stray capacitance C4, for example, may have a capacitance of 10 pF-100 nF or about 50 pF-1 nF, such as, for example, about 200 pF. The stray inductance of the output cable L2, for example, can be less than about 100 μH, less than about 10 μH or less than about 5 μH, or about 2 H.

The sizing of the output cable stray capacitance C4 and stray inductance L2, for example, can be a tradeoff between the charge time, efficiency, output voltage, and energy-per-pulse. Longer output cables, for example, may have a larger stray capacitance C4 and stray inductance L2 values. Output stray capacitance C4 values much larger than the transformer stray capacitance C2 may improve the efficiency of energy delivery to the plasma formed across the spark gap S2. Larger output cable stray inductance L2 values will increase the output charge time. The output stray capacitance C4 value may also be selected with the controlled energy C1 value and charge voltage to achieve the desired output voltage and energy-per-pulse.

The output blocking diode D3, for example, can trap energy that is transferred to the output cable stray capacitance C4. This can be helpful, for example, because the arc across the spark gap S2 may take microseconds to form and/or form at inconsistent times.

Once the arc forms, energy rings back and forth through the plasma, the output cable stray inductance L2, and the output cable stray capacitance C4. Energy gets absorbed into the plasma. The resistance of the plasma, for example, can influence how much energy ends up in the plasma. This circuit has been designed to minimize the impact of the plasma on the energy delivered.

In the whole system, energy flows from the second energy storage capacitor C13 to the first energy storage capacitor C1, from the first energy storage capacitor C1 to the output cable stray capacitance C4, then finally from the output cable stray capacitance C4 to the plasma.

If an arc doesn't form across the spark gap S2, the bleed resistor R2 can slowly bring down the output voltage over many microseconds. The bleed resistor R2, for example, may have a resistance of about 1 MΩ-100 MΩ such as, for example, 10 MΩ. Alternatively or additionally, the bleed resistor R2, for example, may have a resistance of about 1 kΩ-1 MΩ.

Alternatively or additionally, the output may include a switch coupled with the bleed resistor R2 or instead of the bleed resistor R2.

The pulse width of the switch S1 can be timed such that its opening corresponds to about when the largest output cable stray capacitance C4 value becomes fully charged. The current flowing through the primary of transformer T1 may, for example, be zero at that time. With variable charge voltages, different values for the output cable stray capacitance C4, the ringing of the stray capacitance of the transformer C2, and an unknown arc formation time, it may be impossible to guarantee that no current will be flowing through the switch S1 during opening.

The snubber circuit for the switch S1, may protect the solid-state devices and allow them to open even when current is flowing through the primary of transformer T1. The maximum possible current may occur when an arc forms early during the charging of the output cable stray capacitance C4 value. An arc formation can create a spike in the primary current. When the arc forms early, this spike can add to the nominal current of the pulsed charging. The snubber circuit can be sized and configured to handle the switch S1 opening against the maximum possible current.

The energy delivered to the plasma from the driver and load system 100 can be dependent on when the user's arc forms at the spark gap S2. For example, the maximum energy is delivered to the plasma when the arc forms right when the output reaches the maximum voltage. At this point, all or almost all the energy on the output has the potential to be absorbed by the plasma.

If an arc forms early, such as, for example, during charging, the only energy that can be absorbed by the plasma is what's already on the output (e.g., at the spark gap S2, or at capacitance of the transformer C2, or at the output cable stray capacitance C4). Any remaining energy, for example, can flow back to the first energy storage capacitor C1 since the switch S1 and the spark gap S2 are both conducting. The energy on the first energy storage capacitor C1 is in the form of a negative voltage. Before the next pulse, that negative voltage can flip positive by flowing through the crowbar diode D5. This feature may improve the overall input efficiency of the plasma driver 101 by recovering energy not absorbed by the plasma to use for the next pulse.

When the plasma does not absorb most of the energy, the plasma driver 101 does not run as efficiently as possible due to conduction losses of internal components. There are places within the plasma driver 101 to monitor the temperature of the transformer T1 core, switch S1, and/or output diode D3 with IR sensors or thermocouples or other thermometers. If any of those components go above a set temperature, a thermal fault will trip and stop drive signals until the components can cool down to a safe level.

When a thermal fault occurs the user can, for example, either decrease the charge voltage or increase the spacing of the spark gap S2 such that the output reaches the maximum voltage. Alternatively, the user could also decrease the PRF. Either of these options will reduce the amount of energy being dissipated by internal components losses, but only the former option will improve the efficiency of the energy delivered to the plasma.

If the arc forms after the output reaches the maximum voltage, efficiency is decreased but to a much lesser extent than if the arc forms before the output reaches the maximum voltage. After the output reaches the maximum voltage, the stray capacitance of the transformer C2 begins ringing with the transformer T1 magnetizing inductance and other primary components. As long as the stray capacitance of the transformer C2 has a smaller value than the output cable stray capacitance stray capacitance C4, the arc forming later is less consequential.

If no arc forms, the user must wait for the bleed resistor R2 to fully discharge the output cable stray capacitance C4 before sending in another pulse. Otherwise, the energy transferred to the output will build on the energy that hasn't dissipated, which could result in an over-voltage event. The bleed resistor R2 is also used as a voltage divider to measure the output voltage. When the output voltage goes above the set limit, an over-voltage fault will trip. Drive signals are stopped until the plasma driver 101 receives a reset signal. As another example, an over-voltage fault can occur if the user's charge voltage is too high for the output cable stray capacitance C4 value.

Even though the output voltage is limited to a certain value, higher voltages will be present within plasma driver 101, specifically across the transformer T1 secondary. When the stray capacitance of the transformer C2 rings back, it does so through a large inductance that over-charges the stray capacitance of the transformer C2. The overcharge can be as much as twice the output voltage. Notice that because the blocking diode D3, of the output stage 104, holds the output voltage, when transformer T1 rings back, the differential voltage across the blocking diode D3 can be as high as three times the output voltage. The voltage rating of the blocking diode, for example, may be sized accordingly.

Multiple plasma driver 101 units may be used in series and/or parallel, for example, to drive a single spark gap S2. For example, multiple plasma driver 101 units may be connected parallel to a single spark gap S2 to increase the energy-per-pulse delivered to the user's plasma. Another example, one positive and one negative output plasma driver 101 may be connected in series to increase the total output voltage, increase the energy-per-pulse delivered to the user's plasma, and/or drive a floating spark gap S2.

The nanosecond pulser stage 110 and/or the IPM stage 105 and, in some cases, possibly with the output blocking diode D3, produce waveforms that are substantially pulse shaped as shown in FIG. 3B rather than substantially sinusoidal as shown in FIG. 3A. Pulsed shaped waveforms have a pulse repetition frequency, a pulse width, a rise time, an amplitude (or voltage) and/or a fall time, whereas sinusoidal waveforms have an amplitude (or voltage) and frequency. Pulsed waveforms may or may not be periodic. A pulsed waveform may be more like a square waveform than a sinusoidal waveform.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A plasma driver comprising:
an energy storage capacitor;
a nanosecond pulser stage electrically coupled with the energy storage capacitor, wherein the nanosecond pulser stage produces high voltage pulses greater than about 1 kV;
an IPM stage electrically coupled with the nanosecond pulser stage and the energy storage capacitor, wherein the IPM stage produces high voltage pulses of about 1 V-10 kV;
a transformer electrically having a primary side and a secondary side, the primary side electrically coupled with the nanosecond pulser stage and the IPM stage; and
an output cable electrically coupled with a secondary side of the transformer.

2. (canceled)

3. (canceled)

4. (canceled)

5. (canceled)

6. (canceled)

7. (canceled)

8. (canceled)

9. (canceled)

10. (canceled)

11. (canceled)

12. The plasma driver according to claim 1, further comprising a power supply coupled with the IPM stage.

13. The plasma driver according to claim 1, wherein the nanosecond pulser stage comprises a plurality of solid-state switches arranged in parallel.

14. (canceled)

15. The plasma driver according to claim 1, wherein the nanosecond pulser stage produces high voltage pulses of about 5 kV-30 kV.

16. The plasma driver according to claim 1, wherein the nanosecond pulser stage produces high voltage pulses with a pulse repetition frequency greater than about 100 Hz.

17. The plasma driver according to claim 1, wherein the nanosecond pulser stage produces high voltage pulses with a pulse repetition frequency between 1 kHz and 50 kHz.

18. (canceled)

19. The plasma driver according to claim 1, wherein the IPM stage comprises plurality of solid-state switches arranged in parallel.

20. The plasma driver according to claim 1, wherein the IPM stage produces high voltage pulses of about 1 V-1 kV

21. The plasma driver according to claim 1, wherein the IPM stage produces high voltage pulses of about 10 V-700 V.

22. The plasma driver according to claim 1, wherein the pulse repetition frequency of the IPM stage and the pulse repetition frequency of the nanosecond pulser stage are about the same.

23. The plasma driver according to claim 1, further comprising a second energy storage capacitor disposed between the nanosecond pulser stage and the IPM stage.

24. (canceled)

25. The plasma driver according to claim 23, wherein the second energy storage capacitor is charged when the plurality of switches of the nanosecond pulser are closed.

26. The plasma driver according to claim 23, wherein the second energy storage capacitor has a capacitance of about 1 nF-100 μF.

27. The plasma driver according to claim 23, wherein the second energy storage capacitor has a capacitance of about 100 nF-1 μF.

28. (canceled)

29. The plasma driver according to claim 1, further comprising a current-limiting inductor disposed between the nanosecond pulser stage and the transformer.

30. (canceled)

31. The plasma driver according to claim 1, proceeding claims, further comprising a bleed resistor disposed across a secondary side of the transformer.

32. The plasma driver according to claim 1, further comprising a blocking diode disposed between the transformer and the output cable.

33. (canceled)

34. (canceled)

35. (canceled)

36. A plasma driver comprising:
a first energy storage capacitor;
a nanosecond pulser electrically coupled with the energy storage capacitor, the nanosecond pulser comprising a plurality of solid state switches, wherein the nanosecond pulser stage produces high voltage pulses greater than about 1 kV, wherein the nanosecond pulser stage produces high voltage pulses with a pulse repetition frequency greater than about 100 Hz;
a second energy storage capacitor;
an integrated power module comprising a plurality of solid state switches, wherein the integrated power module is electrically coupled with the first energy storage capacitor and the nanosecond pulser via the second energy storage capacitor, wherein the integrated power module stage produces high voltage pulses of about 1 V-10 kV;
a transformer having a primary side and a secondary side, the primary side having a first lead electrically coupled with the nanosecond pulser and a second lead electrically coupled with the integrated power module; and
an output electrically coupled with the secondary side of the transformer.

37. The plasma driver according to claim 36, further comprising an output cable electrically coupled with an output.

38. The plasma driver according to claim 36, wherein the nanosecond pulser stage comprises a plurality of solid-state switches arranged in parallel.

39. (canceled)

40. (canceled)

41. (canceled)

42. The plasma driver according to claim 36, wherein the second energy storage capacitor has a capacitance of about 100 nF-1 μF.

43. The plasma driver according to claim 36, further comprising a current-limiting inductor disposed between the nanosecond pulser stage and the transformer.

44. (canceled)

45. (canceled)

46. (canceled)

47. (canceled)

48. The plasma driver according to claim 36, wherein the stray capacitance of the transformer is less than about 500 pF.

49. The plasma driver according to claim 36, wherein the plurality of switches of the integrated power module are open when the plurality of switches of the nanosecond pulser are closed, and wherein the plurality of switches of the integrated power module are closed when the plurality of switches of the nanosecond pulser are open.
